(19) United States
(12) Patent Application Publication
(10) Pub. No.: US 2024/0079167 A1
(43) Pub. Date: Mar. 7, 2024

(54) SOFT MAGNETIC MATERIAL AND ELECTRONIC COMPONENT

(71) Applicant: Alps Alpine Co., Ltd., Tokyo (JP)

(72) Inventors: Kenji YOSHIDA, Tokyo (JP); Seiichi ABIKO, Niigata-ken (JP); Shigeru KOBAYASHI, Niigata-ken (JP); Hisato KOSHIBA, Niigata-ken (JP); Kazuya OMINATO, Niigata-ken (JP)

(21) Appl. No.: 18/363,561

(22) Filed: Aug. 1, 2023

(30) Foreign Application Priority Data
Sep. 5, 2022 (JP) 2022-140973

(51) Int. Cl. H01F 1/20

(52) U.S. Cl. CPC H01F 1/20

(57) ABSTRACT

A soft magnetic material according to an aspect of the present invention includes a powder-particle substance having a particle size frequency distribution having a plurality of peak tops. The powder-particle substance is an aggregate of composite particles containing a plurality of soft magnetic metal particles and includes a medium powder-particle substance in which the composite particles have a particle size of 45 μm or more and less than 300 μm, and the medium powder-particle substance has an average circularity of 0.7 or more.

### CLAIM OF PRIORITY

This application claims benefit of Japanese Patent Application No. 2022-140973 filed on Sep. 5, 2022, which is hereby incorporated by reference.

### BACKGROUND OF THE INVENTION

### 1. Field of the Invention

The present invention relates to a soft magnetic material and an electronic component.

### 2. Description of the Related Art

Conventionally, dust cores have been used for electronic components such as inductors, reactors, transformers, and choke coils. In general, a dust core is produced in a manner that a soft magnetic material such as granulated powder containing soft magnetic powder and a binder is loaded into a mold and pressurized. Electronic components obtained using such dust cores are incorporated in various electronic and electrical devices such as information devices. For application to high-power or large-sized electronic and electrical devices such as hybrid vehicle converters, such electronic components have recently been developed.

For the production of a dust core, a large amount of soft magnetic material is used. For example, as the dust core size increases, the amount of soft magnetic material used increases. Furthermore, the soft magnetic material used for the production of a dust core is allowed to have a larger particle size. Accordingly, when a soft magnetic material is granulated so as to have a larger target particle size, the resulting soft magnetic material may contain both granulated powder having the target particle size and granulated powder having a particle size smaller than the target particle size, and moreover the shape of these granulated powders may be indeterminate. In this case, the granulated powders contained in the soft magnetic material have widely varying particle sizes, and thus the soft magnetic material has a wider particle size distribution.

However, the wider the particle size distribution of a soft magnetic material is, the lower the fluidity of the soft magnetic material may be. This may cause problems such as uneven loading of the soft magnetic material in a mold during the production of a dust core. That is, a decrease in the fluidity of the soft magnetic material may cause decreases in the production efficiency and yield of the dust core. Techniques for increasing the fluidity of a powder-particle substance or powder containing a plurality of particles, such as the above-described soft magnetic material, are disclosed in, for example, Japanese Unexamined Patent Application Publication No. 3-114522, Japanese Unexamined Patent Application Publication No. 2019-033227, and Japanese Unexamined Patent Application Publication No. 2018-210820.

### SUMMARY OF THE INVENTION

To increase the fluidity of a soft magnetic material, in addition to the techniques disclosed in Japanese Unexamined Patent Application Publication No. 3-114522, Japanese Unexamined Patent Application Publication No. 2019-033227, and Japanese Unexamined Patent Application Publication No. 2018-210820 above, it is effective to make the particle size of the soft magnetic material uniform to achieve a narrow particle size distribution by classifying the soft magnetic material using a vibrating sieve or the like. However, when the particle size distribution of the soft magnetic material is narrowed as described above, a higher proportion of the granulated soft magnetic material is excluded by the classification, thus increasing the loss of the soft magnetic material (hereinafter referred to as the material loss) in the production of a dust core and resulting in a lower yield.

The present invention has been made in view of the foregoing circumstances, and provides a soft magnetic material that can achieve a reduction in material loss while achieving high fluidity and an electronic component.

(1) A soft magnetic material according to an aspect of the present invention includes a powder-particle substance having a particle size frequency distribution having a plurality of peak tops. The powder-particle substance is an aggregate of composite particles containing a plurality of soft magnetic metal particles and includes a medium powder-particle substance in which the composite particles have a particle size of 45 μm or more and less than 300 μm, and the medium powder-particle substance has an average circularity of 0.7 or more.

(2) In the soft magnetic material according to (1), when the particle size frequency distribution is separated into a plurality of peaks having a peak top corresponding to each of the plurality of peak tops, the plurality of peaks may include a first peak having a peak top to which a largest particle size corresponds and a second peak having a peak top to which a second largest particle size after the particle size at the first peak corresponds, and a ratio A_{β} of a peak area of the second peak to a total area of the plurality of peaks may be 0.20 or more.

(3) In the soft magnetic material according to (2), the plurality of peaks may further include one or more third peaks each having a peak top to which a particle size smaller than the particle size at the second peak corresponds, a ratio A_{γ} of a sum of peak areas of the one or more third peaks to the total area of the plurality of peaks may be 0.15 or less, and the ratio A_{γ} may be smaller than both a ratio A_{α} of a peak area of the first peak to the total area of the plurality of peaks and the ratio A_{β}.

(4) In the soft magnetic material according to (1), in a cumulative particle size distribution of the powder-particle substance, a ratio D90/D10 obtained by dividing D90 which is a particle size corresponding to a cumulative frequency at 90% by D10 which is a particle size corresponding to a cumulative frequency at 10% may be 20.0 or less.

(5) In the soft magnetic material according to (1), in a cumulative particle size distribution of the powder-particle substance, D50 which is a particle size corresponding to a cumulative frequency at 50% may be 200 μm or more.

(6) In the soft magnetic material according to (5), D50 may be 650 μm or less.

(7) In the soft magnetic material according to (1), in a cumulative particle size distribution of the powder-particle substance, D90 which is a particle size corresponding to a cumulative frequency at 90% may be 850 μm or less.

(8) In the soft magnetic material according to (1), a proportion of an area occupied by the plurality of soft magnetic metal particles relative to an area of a section of each of the composite particles may be 60% or more.

(9) In the soft magnetic material according to (1), in a cumulative particle size distribution of the powder-particle substance, a ratio D90/D10 obtained by dividing D90 which is a particle size corresponding to a cumulative frequency at 90% by D10 which is a particle size corresponding to a cumulative frequency at 10% may be 5.0 or more and 11.0 or less, in the cumulative particle size distribution of the powder-particle substance, D50 which is a particle size corresponding to a cumulative frequency at 50% may be 200 μm or more and 460 μm or less, and in 100 or more of the composite particles selected from the powder-particle substance, a proportion of the composite particles having a ratio Dₘₐₓ/Dₘᵢₙ of 2.0 or less may be 80% or more, the ratio Dₘₐₓ/Dₘᵢₙ being a ratio of a maximum diameter Dₘₐₓ to a minimum diameter Dₘᵢₙ.

(10) In the soft magnetic material according to (1), the composite particles may contain a binder binding the plurality of soft magnetic metal particles together, a hardness of the binder may be not more than 0.25 times a hardness of the soft magnetic metal particles, the soft magnetic metal particles may be amorphous soft magnetic particles, and in a cumulative particle size distribution of the plurality of soft magnetic metal particles, D90p which is a particle size corresponding to a cumulative frequency at 90% may be 150 μm or less.

(11) An electronic component according to an aspect of the present invention includes the soft magnetic material according to (1).

### BRIEF DESCRIPTION OF THE DRAWINGS

FIG. 1 is a view showing an example of a soft magnetic material according to an embodiment of the present invention;

FIG. 2 is a graph showing an example of a particle size frequency distribution of a soft magnetic material according to an embodiment of the present invention;

FIG. 3 is a view showing an example of a section of a composite particle included in a soft magnetic material according to an embodiment of the present invention;

FIG. 4 is an enlarged view of the section of the composite particle shown in FIG. 3; and

FIG. 5 is a graph showing the correlation between the average circularity C₂ and the angle of repose φ in each of Examples 1 to 15 and Comparative Examples 1 to 4.

### DESCRIPTION OF THE PREFERRED EMBODIMENTS

Hereinafter, preferred embodiments of a soft magnetic material and an electronic component according to the present invention will be described in detail with reference to the attached drawings. It should be noted that the present invention is not limited by the following embodiments. The figures illustrate schematic examples. In each figure, the dimensional relationships among elements, the ratios of the dimensions of the elements, and other dimensional conditions may differ from those of actual products. Also among the figures, the dimensional relationships and ratios of the elements may differ. In the figures, substantially the same elements are indicated by like numbers.

### Configuration of Soft Magnetic Material

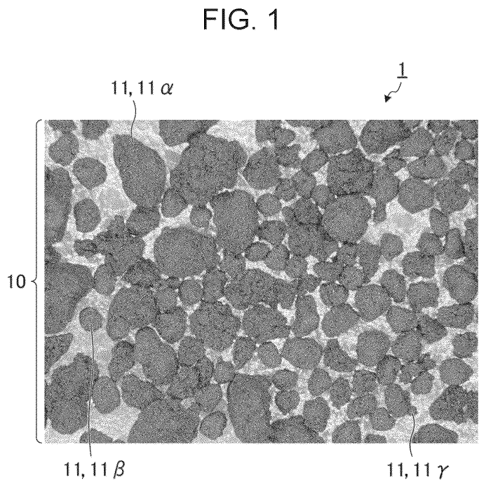

First, a configuration of a soft magnetic material according to an embodiment of the present invention will be described. FIG. 1 is a view showing an example of a soft magnetic material according to an embodiment of the present invention. In FIG. 1, an optical micrograph (OM) of an appearance of a soft magnetic material 1 according to this embodiment is shown.

As shown in FIG. 1, the soft magnetic material 1 according to this embodiment is formed of a powder-particle substance containing particles with a wide particle size range, for example, a powder-particle substance 10 having a particle size frequency distribution having a plurality of peak tops. Specifically, the powder-particle substance 10 is an aggregate of soft magnetic composite particles 11 with a wide particle size range. For example, as shown in FIG. 1, the plurality of composite particles 11 included in the powder-particle substance 10 can be classified into a group of composite particles 11α having a relatively large particle size, a group of composite particles 11β having a moderate particle size, and a group of composite particles 11γ having a relatively small particle size. The composite particles 11β having a moderate particle size are composite particles having a particle size between that of the composite particles 11α and that of the composite particles 11γ.

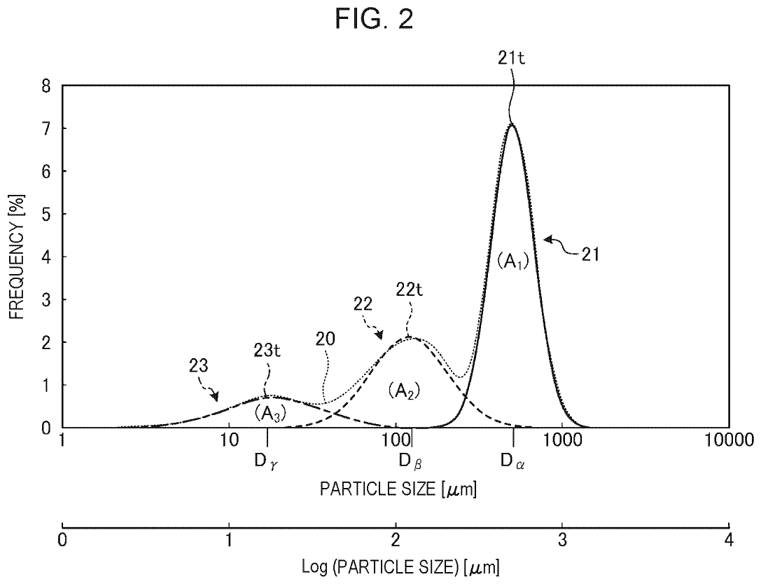

FIG. 2 is a graph showing an example of a particle size frequency distribution of a soft magnetic material according to an embodiment of the present invention. In the soft magnetic material 1 according to this embodiment, the powder-particle substance 10 has a particle size frequency distribution 20 having a plurality of peak tops, that is, a plurality of local maximum frequency values. The particle size frequency distribution 20 can be separated, according to the plurality of peak tops included therein, into a plurality of peaks. A peak top of each of these plurality of separated peaks corresponds to each of the plurality of peak tops included in the particle size frequency distribution 20 before the separation. Specifically, the particle size frequency distribution 20 is measured with a dry laser-diffraction particle size distribution analyzer. The particle size frequency distribution 20, when its peaks are each expressed as a lognormal distribution, is approximated by the sum of the same number of peaks as the number of peak tops. That is, the particle size frequency distribution 20, when its peaks are each expressed as a lognormal distribution, can be expressed as separated into the same number of peaks as the number of peak tops. For example, as shown in FIG. 2, the particle size frequency distribution 20 is the sum of a first peak 21, a second peak 22, and a third peak 23.

Among the plurality of peaks included in the particle size frequency distribution 20, the first peak 21 is a peak having a peak top to which the largest particle size corresponds. Specifically, as shown in FIG. 2, the first peak 21 has a peak top 21t at a particle size D_{α}. The particle size D_{α} corresponding to the peak top 21t is larger than both a particle size D_{β} corresponding to a peak top 22t of the second peak 22 and a particle size D_{γ} corresponding to a peak top 23t of the third peak 23.

Among the plurality of peaks included in the particle size frequency distribution 20, the second peak 22 is a peak having a peak top to which the second largest particle size after the particle size at the first peak 21 corresponds. Specifically, as shown in FIG. 2, the second peak 22 has the peak top 22t at the particle size D_{β}. The particle size D_{β} corresponding to the peak top 22t is smaller than the particle size D_{α} corresponding to the peak top 21t of the first peak 21 and larger than the particle size D_{γ} corresponding to the peak top 23t of the third peak 23.

Among the plurality of peaks included in the particle size frequency distribution 20, the third peak 23 is a peak having a peak top to which a particle size smaller than the particle size at the second peak 22 corresponds. Specifically, as shown in FIG. 2, the third peak 23 has the peak top 23t at the particle size D_{γ}. The particle size D_{γ} corresponding to the peak top 23t is smaller than both the particle size D_{α} corresponding to the peak top 21t of the first peak 21 and the particle size D_{β} corresponding to the peak top 22t of the second peak 22.

In the soft magnetic material 1 according to this embodiment, the powder-particle substance 10 is an aggregate of the composite particles 11 with indeterminate shapes, as shown in FIG. 1. When the powder-particle substance 10 is classified with a sieve, the powder-particle substance 10 includes a medium powder-particle substance in which the composite particles 11 have a particle size of 45 μm or more and less than 300 μm. From the viewpoint of improving the fluidity of the powder-particle substance 10, the medium powder-particle substance has an average circularity of 0.7 or more. The upper limit of the average circularity is 1.0.

In this specification, the average circularity is an average of circularities of the plurality of composite particles 11 and is calculated by summing up calculated circularities of the plurality of composite particles 11 and dividing the sum by the number of the composite particles 11 subjected to circularity calculation. The circularity of each composite particle 11 is determined by acquiring a two-dimensional image of the composite particle 11 of interest using a digital microscope or the like, deriving an area and a perimeter of the composite particle 11 in the two-dimensional image, and making a calculation based on the area and the perimeter obtained.

The fluidity of the soft magnetic material 1 according to this embodiment is the fluidity of the powder-particle substance 10 and is evaluated by the angle of repose of the powder-particle substance 10. The smaller the angle of repose of the powder-particle substance 10, the higher the fluidity of the powder-particle substance 10, and the greater the angle of repose of the powder-particle substance 10, the lower the fluidity of the powder-particle substance 10. The angle of repose of the powder-particle substance 10 is determined by a method in accordance with JIS Z 2504 by depositing the powder-particle substance 10 on a circular base plate in an excessive amount relative to the base plate, and making a calculation based on the deposition height of the powder-particle substance 10 thus deposited in a conical shape and the radius of the base plate. From the viewpoint of securing the fluidity of the powder-particle substance 10 suitable for the production of a dust core, the angle of repose of the powder-particle substance 10 is preferably 36° or less, more preferably 35° or less, still more preferably 34° or less. When the soft magnetic material 1 has high fluidity, the occurrence of unexpected powder troubles such as blocking and ratholing can be prevented, thus increasing the production efficiency of a dust core.

In the particle size frequency distribution 20 (see FIG. 2) of the powder-particle substance 10 according to this embodiment, the relationship described below is preferably established between a peak area A₁ of the first peak 21, a peak area A₂ of the second peak 22, and a peak area A₃ of the third peak 23.

Specifically, when the particle size frequency distribution 20 includes at least the first peak 21 and the second peak 22, the ratio of the peak area A₂ of the second peak 22 to the total peak area of the particle size frequency distribution 20 (hereinafter referred to as a peak area ratio A_{β}) is preferably 0.20 or more. Here, the total peak area of the particle size frequency distribution 20 is a total area of the plurality of peaks included in the particle size frequency distribution 20. For example, as shown in FIG. 2, when the particle size frequency distribution 20 is constituted by the first peak 21, the second peak 22, and the third peak 23, the total peak area is the sum total of the peak area A₁, the peak area A₂, and the peak area A₃ (A₁+A₂+A₃). In this case, the peak area ratio A_{β} is calculated by the following formula:

A_{β}=A₂/(A₁+A₂+A₃)

When the particle size frequency distribution 20 includes at least the first peak 21, the second peak 22, and one or more third peaks 23, the ratio of the sum of peak areas A₃ of the one or more third peaks 23 to the total peak area of the particle size frequency distribution 20 (hereinafter referred to as a peak area ratio A_{γ} ) is preferably 0.15 or more. For example, as shown in FIG. 2, when the particle size frequency distribution 20 is constituted by the first peak 21, the second peak 22, and one third peak 23, the peak area ratio A_{γ} is calculated by the following formula:

A_{γ}=A₃/(A₁+A₂+A₃)

When the particle size frequency distribution 20 has four or more peak tops, among four or more peaks that are included in the particle size frequency distribution 20 so as to correspond to the four or more peak tops, two or more peaks other than the first peak 21 and the second peak 22 are all regarded as third peaks 23. In this case, the peak area A₃ is given by the sum of areas of the two or more third peaks 23.

Furthermore, the peak area ratio A_{γ} of the third peak 23 described above is preferably smaller than both a peak area ratio A₆₀ of the first peak 21 and the peak area ratio A_{β} of the second peak 22. Here, the peak area ratio A_{α} is the ratio of the peak area A₁ of the first peak 21 to the total peak area of the particle size frequency distribution 20. For example, as shown in FIG. 2, when the particle size frequency distribution 20 includes the first peak 21, the second peak 22, and the third peak 23, the peak area ratio A_{α} is calculated by the following formula:

A_{α}=A₁/(A₁+A₂+A₃)

In this specification, the particle size frequency distribution is a volume-based particle size distribution obtained with a dry particle size distribution analyzer in accordance with JIS Z 8825-1. The peak area is derived by executing a curve fitting process using a function of lognormal distribution according to the number of peak tops included in a particle size frequency distribution graph (Y-axis: frequency, X-axis: particle size), and integrating the resulting solution (a function representing a curve of a peak) with a particle size range (measurement range) designated while the common logarithm of particle size is taken. For the peak area, the same result as above is derived also by executing a curve fitting process using a function of normal distribution according to the number of peak tops included in a graph in which the common logarithm (the logarithm to the base 10) of particle size is plotted on the X-axis and the frequency is plotted on the Y-axis (a graph in which values on the X-axis of the particle size frequency distribution are replaced with values of the logarithm of particle size), and integrating the resulting solution (a function representing a curve of a peak) with a particle size range (measurement range) designated.

In the soft magnetic material 1 (see FIG. 1) according to this embodiment, D10, D50, and D90 in a cumulative particle size distribution of the powder-particle substance 10 preferably satisfy the relationship described below. Here, D10 is a particle size of the powder-particle substance 10 corresponding to a cumulative frequency at 10%. D50 is a particle size (median diameter) of the powder-particle substance 10 corresponding to a cumulative frequency at 50%. D90 is a particle size of the powder-particle substance 10 corresponding to a cumulative frequency at 90%. D10 (×10), D50 (×50), and D90 (×90) are obtained from a volume-based cumulative particle size distribution (e.g., an output corresponding to a cumulative undersize distribution) obtained with a dry particle size distribution analyzer in accordance with JIS Z 8825-1. The cumulative frequency is a frequency accumulated from smaller particle sizes to larger particle sizes in the particle size frequency distribution.

Specifically, the upper limit of the particle size of the composite particles 11 included in the powder-particle substance 10 is preferably set according to the size of a dust core produced using the powder-particle substance 10. For example, in the powder-particle substance 10, D90 is preferably 850 μm or less. That is, the particle size of the composite particles 11 at a time point when the cumulative frequency obtained by accumulating frequencies in the volume-based particle size frequency distribution from smaller particle sizes to larger particle sizes reaches 90% is preferably 850 μm or less. A ratio D90/D10 obtained by dividing D90 by D10 indicates the width of the particle size frequency distribution. To further increase the fluidity of the powder-particle substance 10, the ratio D90/D10 is preferably 20.0 or less, more preferably 15.0 or less, still more preferably 11.0 or less. In this case, the versatility of the shape of the dust core can also be increased. To further increase the yield of the dust core, the ratio D90/D10 is preferably 2.0 or more, more preferably 3.0 or more, still more preferably 5.0 or more. In this case, magnetic properties can also be enhanced due to an increase in density of the dust core.

When a relatively large dust core is produced with high production efficiency, D50 is preferably 50 μm or more, more preferably 100 μm or more, still more preferably 150 μm or more, most preferably 200 μm or more. When a relatively small dust core is produced with high production efficiency, D50 is preferably 650 μm or less, more preferably 600 μm or less, still more preferably 500 μm or less, most preferably 460 μm or less. In this case, the versatility of the shape of the dust core can also be increased. In particular, when the ratio D90/D10 is 5.0 or more and 11.0 or less, D50 is preferably 200 μm or more and 460 μm or less.

From the viewpoint of increasing the fluidity of the powder-particle substance 10, a ratio Dₘₐₓ/Dₘᵢₙ of a maximum particle size (hereinafter referred to as a maximum diameter Dₘₐₓ) to a minimum particle size (hereinafter referred to as a minimum diameter Dₘᵢₙ) of the plurality of composite particles 11 included in the powder-particle substance 10 is preferably 2.0 or less. In particular, in 100 or more of the composite particles 11 randomly selected from the powder-particle substance 10, the proportion of the composite particles 11 having a ratio Dₘₐₓ/Dₘᵢₙ of 2.0 or less is more preferably 80% or more, the ratio Dₘₐₓ/Dₘᵢₙ being a ratio of a maximum diameter Dₘₐₓ to a minimum diameter Dₘᵢₙ. The upper limit of the proportion of the composite particles 11 having a ratio Dₘₓ/Dₘᵢₙ of 2.0 or less is 100%.

In this specification, the maximum diameter Dₘₐₓ is a length of a maximum distance between any two points on the contour line of a composite particle 11 in an image of the composite particle 11 in the powder-particle substance 10 captured using a digital microscope or the like. The minimum diameter Dₘᵢₙ is a length of a minimum distance between any two straight lines parallel to each other sandwiching the contour line of the composite particle 11 in the same image of the composite particle 11 as above.

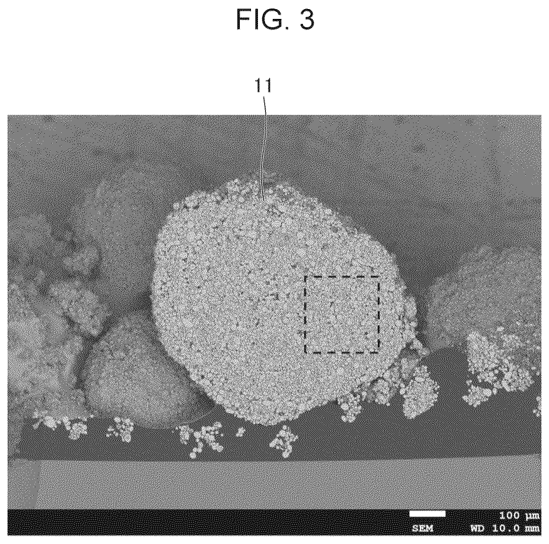

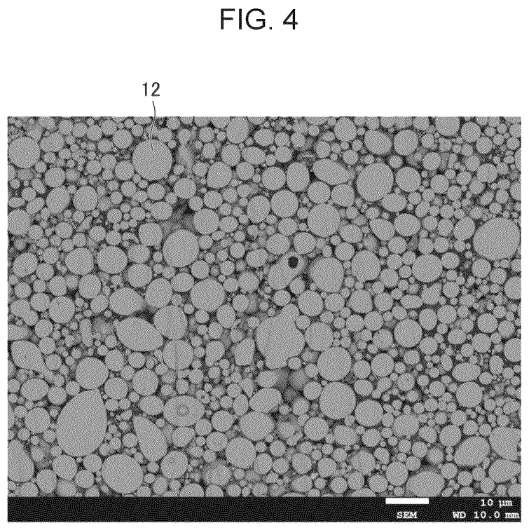

In the soft magnetic material 1 according to this embodiment, the powder-particle substance 10 described above is an aggregate of the composite particles 11 containing a plurality of soft magnetic metal particles. FIG. 3 is a view showing an example of a section of a composite particle included in a soft magnetic material according to an embodiment of the present invention. In FIG. 3, an SEM image showing a section of one composite particle 11 selected from the powder-particle substance 10 is shown. FIG. 4 is an enlarged view of the section of the composite particle shown in FIG. 3. In FIG. 4, an enlarged SEM image of a partial region surrounded by a dashed line in the section of the composite particle 11 shown in FIG. 3 is shown.

As shown in FIGS. 3 and 4, the composite particles 11 contain a plurality of soft magnetic metal particles 12. In each of the composite particles 11, the plurality of soft magnetic metal particles 12 are bound together through a binder (not shown). The particle size of each of the plurality of soft magnetic metal particles 12 is not particularly limited as long as it does not exceed the particle size of the composite particles 11 to be granulated. From the viewpoint of increasing the density of the soft magnetic metal particles 12 contained in the composite particles 11 in order to provide a dust core with enhanced magnetic properties, D90p in a cumulative particle size distribution of the plurality of soft magnetic metal particles 12 is preferably 200 μm or less, more preferably 150 μm or less, still more preferably 80 μm or less. D90p may be 5 μm or more. In this specification, D90p is a particle size corresponding to a cumulative frequency at 90% in the cumulative particle size distribution of the plurality of soft magnetic metal particles 12 contained in the composite particles 11. D90p is obtained from a volume-based cumulative particle size distribution (e.g., an output corresponding to a cumulative undersize distribution) measured with a dry particle size distribution analyzer in accordance with JIS Z 8825-1.

The shape of each of the plurality of soft magnetic metal particles 12 may be spherical or non-spherical. The non-spherical shape may be, for example, a shape having shape anisotropy, such as a scale-like shape, an elliptical spherical shape, a droplet shape, or a needle-like shape, or may be an indeterminate shape having no particular shape anisotropy. Examples of such indeterminate soft magnetic metal particles 12 include a plurality of spherical soft magnetic metal particles 12 combined in contact with each other and a plurality of differently-shaped soft magnetic metal particles 12 combined so as to be partially embedded in each other.

From the viewpoint of increasing the density of the soft magnetic metal particles 12 contained in the composite particles 11 in order to provide a dust core with enhanced magnetic properties, the occupancy of the plurality of soft magnetic metal particles 12 in a section of each of the composite particles 11 is preferably 50% or more, more preferably 60% or more. The occupancy of the plurality of soft magnetic metal particles 12 is a proportion of an area occupied by the plurality of soft magnetic metal particles 12 relative to the area of the section of each of the composite particles 11.

Each of the plurality of soft magnetic metal particles 12 described above is, for example, a crystalline soft magnetic particle, an amorphous soft magnetic particle, or a nanocrystalline soft magnetic particle. The crystalline soft magnetic particle is a soft magnetic metal particle having a structure formed of a crystal phase. The amorphous soft magnetic particle is a soft magnetic metal particle in which the volume of an amorphous phase is more than 50% of the entire structure. The nanocrystalline soft magnetic particle is a soft magnetic metal particle having a nanocrystalline structure at more than 50% of the entire structure. The nanocrystalline structure is a structure in which crystal grains having an average crystal grain size of 1 nm to 60 nm are dispersed in a matrix phase. For a smaller iron loss, the plurality of soft magnetic metal particles 12 are preferably soft magnetic particles including an amorphous phase. Examples of the soft magnetic particles including an amorphous phase include amorphous soft magnetic particles and nanocrystalline soft magnetic particles in which crystal grains of 1 nm to 60 nm are dispersed in an amorphous phase.

Examples of materials of the crystalline soft magnetic particle include Fe—Si—Cr-based alloys, Fe—Ni-based alloys, Fe—Co-based alloys, Fe—V-based alloys, Fe—Al-based alloys, Fe—Si-based alloys, Fe—Si—Al-based alloys, carbonyl iron, and pure iron. Examples of materials of the amorphous soft magnetic particle include iron-base amorphous alloys. Examples of iron-base amorphous alloys include Fe—Si—B-based alloys, Fe—P—C-based alloys, and Co—Fe—Si—B-based alloys. Examples of materials of the nanocrystalline soft magnetic particle include Fe—Cu-M-Si—B-based alloys, Fe-M-B-based alloys, and Fe—Cu-M-B-based alloys. In these materials, M is at least one metal element selected from the group consisting of Nb, Zr, Ti, V, Mo, Hf, Ta, and W. The plurality of soft magnetic metal particles 12 may be formed of one kind of material or a plurality of kinds of materials. From the viewpoint of enhancing the magnetic properties while reducing the cost, the plurality of soft magnetic metal particles 12 preferably contain 60 to 100 atom % of Fe.

The binder, among components contained in each of the composite particles 11, is a component that binds the plurality of soft magnetic metal particles 12 together. From the viewpoint of increasing the insulating properties of the composite particles 11 (and hence the insulating properties of the powder-particle substance 10 used in the production of a dust core), the binder is preferably an insulating component. Examples of materials of such a binder include organic materials and inorganic materials.

Examples of organic materials include organic resins such as acrylic resins, silicone resins, epoxy resins, phenol resins, urea resins, and melamine resins. Of these, silicone resins are preferred from the viewpoint of heat resistance of the binder. Examples of inorganic materials include glass particles. From the viewpoint of relaxing the strain of the binder, glass particles are suitable for use as the binder in the composite particles 11. The binder may contain an organic material alone, may contain an inorganic material alone, or may contain both an organic material and an inorganic material.

The composite particles 11 may contain additives such as a lubricant and a coupling agent in addition to the binder described above. Examples of the lubricant include zinc stearate and aluminum stearate. Examples of the coupling agent include silane coupling agents.

As shown in FIGS. 3 and 4, when a binder is binding the plurality of soft magnetic metal particles 12 together in the granulated composite particles 11, the hardness of the binder is preferably not more than 0.25 times the hardness of the soft magnetic metal particles 12 bound together. In this specification, the hardness is a hardness (Vickers hardness) measured by a method in accordance with JIS Z 2244. Regarding materials whose hardness is difficult to measure by this method, the hardness is a hardness (ultra-low loaded hardness) measured by a method in accordance with JIS Z 2255.

### Method for Producing Soft Magnetic Material

Next, a method for producing a soft magnetic material according to an embodiment of the present invention will be described. A method for producing the soft magnetic material 1 according to this embodiment includes a powder preparation step of preparing a plurality of soft magnetic metal particles 12 and a granulation step of producing a powder-particle substance 10 which is an aggregate of composite particles 11 containing the plurality of soft magnetic metal particles 12.

In the powder preparation step, the plurality of soft magnetic metal particles 12 are prepared using, for example, a known method such as water atomization. Next, in the granulation step, the plurality of soft magnetic metal particles 12 prepared in the powder preparation step, a binder, and optional additives are mixed in a solvent such as water using, for example, a rotary stirring blade to form into granules. At this time, at least one of the organic material and the inorganic material described above is used as the material of the binder. The lubricant and the coupling agent described above are optionally used as the additives. The granulated product obtained by mixing is crushed as necessary by a known method to adjust the particle size of the granulated product. As a result, the aggregate of the composite particles 11 containing the plurality of soft magnetic metal particles 12 and the binder, that is, the powder-particle substance 10 (granulated product), is produced. The powder-particle substance 10 thus obtained is used as the soft magnetic material 1 according to this embodiment to produce an electronic component (specifically, a dust core).

In the granulation step, the powder-particle substance 10 may be produced by a spray drying process using a device such as a spray dryer from a thick slurry obtained by stirring the plurality of soft magnetic metal particles 12, the material of the binder, and the additives in a solvent. The additives such as the lubricant and the coupling agent, upon heat treatment in producing a dust core using the powder-particle substance 10, are mostly vaporized to disappear and are integrated with the binder.

### Electronic Component

Next, an electronic component according to an embodiment of the present invention will be described. Although not particularly illustrated, the electronic component according to this embodiment includes the soft magnetic material 1 according to this embodiment. Specifically, the electronic component according to this embodiment is, for example, an electronic component including a dust core, such as an inductor, a reactor, a transformer, or a choke coil. The dust core is produced by, for example, loading the powder-particle substance 10 described above into a mold, compression-molding the powder-particle substance 10 into a desired shape, and optionally subjecting the resulting compact to treatment such as heat treatment. In this heat treatment, strain of the composite particles 11 contained in the compact is removed to enhance the magnetic properties of the dust core. The dust core thus containing the soft magnetic material 1 is used as a core of an electronic component (e.g., an inductor, a reactor, a transformer, or a choke coil) incorporated into various electronic and electrical devices such as information devices. In particular, the dust core is suitable for use as a core of a high-power or large-sized electronic component such as an on-board reactor.

As described above, the soft magnetic material according to the above embodiment includes a powder-particle substance having a particle size frequency distribution having a plurality of peak tops, and the powder-particle substance is an aggregate of composite particles containing a plurality of soft magnetic metal particles and includes a medium powder-particle substance in which the composite particles have a particle size of 45 μm or more and less than 300 μm. The medium powder-particle substance has an average circularity of 0.7 or more. As a result, although the powder-particle substance has a wide particle size frequency distribution, the presence of the medium powder-particle substance whose particle shape is close to a spherical shape enables an increase in fluidity of the entire powder-particle substance. Therefore, since it is not necessary to make the particle size of the powder-particle substance uniform (i.e., to narrow the particle size frequency distribution) by classification in order to increase the fluidity of the powder-particle substance, the material loss can be reduced while high fluidity of the soft magnetic material is ensured. Using such a soft magnetic material to produce an electronic component can improve the yield of the production process of the electronic component and can also reduce the cost required for the production of the soft magnetic material and the electronic component.

In the embodiment described above, the powder-particle substance 10 having a particle size frequency distribution having three peak tops has been given as an example, but the present invention is not limited thereto. For example, the particle size frequency distribution of the powder-particle substance 10 may have two peak tops or three or more peak tops.

In the embodiment described above, the case where the peak top 21t of the first peak 21 is the highest, the peak top 23t of the third peak 23 is the lowest, and the peak top 22t of the second peak 22 is lower than the peak top 21t and higher than the peak top 23t in the particle size frequency distribution has been given as an example, but the present invention is not limited thereto. For example, the peak top 22t of the second peak 22 may be higher than the peak top 21t and may be lower than the peak top 23t.

### EXAMPLES

The present invention will now be described more specifically with reference to Examples of the present invention and Comparative Examples for comparison with the present invention. The present invention should not be construed as being limited to Examples and Comparative Examples given below.

### Preparation of Sample

First, a plurality of soft magnetic metal particles prepared by water atomization, a binder, additives, and a solvent were placed into a container and stirred with a rotary stirring blade to obtain a granulated powder thereof. At this time, iron-base amorphous alloy powder was used as the plurality of soft magnetic metal particles. Water was used as the solvent. Thereafter, the granulated powder was sized using a sieve with 850 μm openings. Thus, a powder-particle substance sample was obtained.

The particle size distribution and circularity of the powder-particle substance sample were controlled by appropriately varying granulation conditions such as the rotation rate and rotation time of the rotary stirring blade, the binder content, the amount of water, the solid content, and the kneading temperature (stirring temperature). In the following Examples, the granulation conditions were varied from Example to Example, and powder-particle substance samples different between Examples in particle size distribution and circularity were used. Also in the following Comparative Examples, the granulation conditions were varied from Comparative Example to Comparative Example, and powder-particle substance samples different between Comparative Examples in particle size distribution and circularity were used.

### Measurement of Particle Size Distribution

For the powder-particle substance sample obtained by the above-described preparation method, a volume-based particle size frequency distribution and a cumulative particle size distribution were measured through a dry process by a method in accordance with JIS Z 8825-1 using a particle size distribution analyzer (LS13320) manufactured by Beckman Coulter, Inc. The particle size measurement range was 0.38 to 2000 μm.

### Determination of D10, D50, and D90 of Powder-Particle Substance

From the volume-based cumulative particle size distribution of the powder-particle substance sample obtained by the above method, D10, D50, and D90 defined in JIS Z 8825-1 (2001) were acquired. Furthermore, the ratio D90/D10 was calculated by dividing D90 by D10.

### Calculation of Peak Area Ratio in Particle Size Distribution

For the x-axis of a graph (x-axis: particle size, y-axis: frequency) of the volume-based particle size frequency distribution of the powder-particle substance sample obtained by the above method, values of particle size were changed to common logarithm values of particle size. A curve fitting process was executed on the graph (graph for analysis). For the curve fitting process, a function ƒ(×) represented by formula (1) below in which functions of normal distribution (probability density functions) were added up as many times as the number corresponding to the number n of peak tops was used. In the case of the powder-particle substance samples used, the number of peak tops was two or three.

$$f ( x ) = {\sum }_{i = 1}^{n} [ {a}_{i} * exp \{ - \frac{4 ln 2 {( x - {b}_{i} )}^{2}}{{c}_{i}^{2}} \} ] \qquad ( 1 )$$

In formula (1), aᵢ, bᵢ, and cᵢ are fitting parameters. Parameter aᵢ is the value of y (frequency) corresponding to a peak top of a peak of interest. Parameter bᵢ is the value of x (common logarithm of particle size) corresponding to the peak top of the peak of interest. Parameter cᵢ is the full width at half maximum of the peak of interest.

In the curve fitting process, the values of aᵢ, bᵢ, and cᵢ in formula (1) were read from the graph for analysis (x-axis: common logarithm of particle size, y-axis: frequency), and the read values were inputted into a calculation program as initial values to thereby execute the process. At this time, Scipy Curve_fit, a Python library, was used as the calculation program. The values of ai, bi, and ci in formula (1) were determined by this curve fitting process, and the peaks were each expressed as a function (peak) of normal distribution. From these functions, the particle size at each peak (the particle size corresponding to each peak top) and the peak area were derived. The peak area is calculated by integrating the peak of interest in an integral interval (a particle size range in common logarithm) corresponding to a particle size range where the particle size distribution has been measured. The peak area of the peak of interest among all peaks included in the graph for analysis was divided by the sum total of peak areas of all the peaks to thereby derive the peak area ratio of each peak to the total peak area. The particle size at each peak was calculated as 10 to the power of bᵢ.

### Measurement of Average Circularity of Powder-Particle Substance

To measure the average circularity of the powder-particle substance, the powder-particle substance sample was first separated using a sieve with 45 μm openings and a sieve with 300 μm openings into three particle groups: a particle group with a particle size of 300 μm or more, a particle group (medium powder-particle substance) with a particle size of 45 μm or more and less than 300 μm, and a particle group with a particle size of less than 45 μm. Next, for each of the three particle groups, the circularity of composite particles contained in the powder-particle substance was measured using a digital microscope (VHX-6000) manufactured by Keyence Corporation.

Specifically, a particle group of interest was placed in the observation field of view of the digital microscope, and an image (two-dimensional image) of a plurality of composite particles contained in the particle group was acquired through the digital microscope. The image acquired was inputted into software attached to the digital microscope to derive an area S and a perimeter L of each of the plurality of composite particles in the image. For each composite particle, the area S and the perimeter L thus obtained were substituted into formula (2) below to calculate the circularity C of each composite particle.

C=4×π×S/L2 (2)

Thereafter, for each of the three particle groups described above, the circularity C of each of the plurality of composite particles was sequentially calculated based on formula (2). For each particle group, the sum of the values of the circularity C was averaged to thereby calculate the average circularity of each of the three particle groups. For each of the three particle groups, the number of composite particles used to calculate the circularity C was 10 or more, which was statistically sufficient.

### Measurement of Angle of Repose of Powder-Particle Substance

First, the powder-particle substance sample was deposited on a circular base plate using a bulk specific gravity meter. At this time, in accordance with JIS Z 2504, the powder-particle substance sample was passed through an orifice of the bulk specific gravity meter to feed an excessive amount of the powder-particle substance sample onto the base plate, whereby the powder-particle substance sample was deposited in a conical shape. The feeding of the powder-particle substance sample was stopped after the conical shape formed by the powder-particle substance sample on the base plate became constant. A JIS bulk specific gravity meter manufactured by Tsutsui Scientific Instruments Co., Ltd. was used as the bulk specific gravity meter. A circular plate with a diameter of 32 μmm was used as the base plate.

Thereafter, the deposition height of the powder-particle substance sample forming a conical shape on the base plate was measured with a height gauge. From the deposition height obtained and the radius of the base plate, the angle of repose φ [° ] of the powder-particle substance sample was calculated.

Measurement of Ratio Dₘₐₓ/Dₘᵢₙ of Powder-Particle Substance

In the measurement of the ratio Dₘₐₓ/Dₘᵢₙ of the powder-particle substance, the ratio Dₘₐₓ/Dₘᵢₙ, which is a ratio of maximum diameter Dₘₐₓ to minimum diameter Din of the plurality of composite particles contained in the powder-particle substance sample, is derived.

Specifically, an image (two-dimensional image) of the plurality of composite particles contained in the powder-particle substance sample was acquired using a digital microscope (VHX-6000) manufactured by Keyence Corporation. The image acquired was inputted into software attached to the digital microscope to derive a maximum diameter Dₘₐₓ and a minimum diameter Dₘᵢₙ of each of the plurality of composite particles in the image. As the maximum diameter Dₘₐₓ, a length (unit: μm) of a maximum distance between any two points on the contour line of a composite particle in the image was measured. As the minimum diameter Dₘᵢₙ, a length (unit:μm) of a minimum distance between any two straight lines parallel to each other sandwiching the contour line of the composite particle in the image was measured. The maximum diameter Dₘₐₓ and the minimum diameter Dₘᵢₙ are defined in JIS Z 8900-1 (2008).

Next, at least a predetermined number of composite particles were randomly selected from the powder-particle substance sample, and for each of the composite particles selected, the ratio Dₘₐₓ/Din was calculated. Thereafter, the number of composite particles having a ratio Dₘₐₓ/Dₘᵢₙ of 2.0 or less was divided by the number of composite particles selected, and the resulting value was multiplied by 100 to derive R2.0. R2.0 is the proportion (percentage) of composite particles having a ratio Dₘₐₓ/Dₘᵢₙ of 2.0 or less among at least a predetermined number of composite particles randomly selected from the powder-particle substance sample. The number of composite particles used to calculate R2.0 (the number of composite particles randomly selected from the powder-particle substance sample) was 100 or more, which was statistically sufficient.

### Measurement of Particle Size Distribution of Soft Magnetic Metal Particles in Composite

Particles

In the measurement of the particle size distribution of soft magnetic metal particles in composite particles, the volume-based cumulative particle size distribution of soft magnetic metal particles (here, iron-base amorphous alloy powder) before granulation of the composite particles was measured through a dry process in the same manner as the particle size distribution of the powder-particle substance sample described above. From the cumulative particle size distribution obtained, D90 defined in JIS Z 8825-1 (2001) was derived as D90p corresponding to D90 of the iron-base amorphous alloy powder.

### Measurement of Density of Compact

In the measurement of the density of a compact, the powder-particle substance sample was first loaded into a mold and pressurized with a pressure of 15 t/cm² to thereby fabricate a ring-shaped compact (toroidal core). At this time, a mold having a cavity with an outer diameter of 20 μmm and an inner diameter of 12.6 μmm was used as the mold. Target values of appearance dimensions of the compact to be fabricated were set as follows: outer diameter, 20 mm; inner diameter, 12.7 μmm; thickness, 6.8 μmm.

Next, the appearance dimensions (outer diameter, inner diameter, and thickness) of the compact fabricated as described above were measured using an image dimension measurement system (IM6145, manufactured by Keyence Corporation) and a micrometer (Digimatic Standard Outside Micrometer, manufactured by Mitutoyo Corporation). The volume of the compact was calculated from the appearance dimensions obtained. The mass of the compact was measured using an electronic balance (HF-300N, manufactured by A & D Company, Limited). The density ρ [g/cm³] of the compact was calculated by dividing the mass of the compact by the volume.

### Measurement of Iron Loss

In the measurement of an iron loss, a coil was first wound around the compact fabricated as described above to thereby prepare an electronic component sample (here, a toroidal core). At this time, the number of turns in the primary winding was 40, and the number of turns in the secondary winding was 10. Next, using the electronic component sample, the iron loss Pcv [kW/m³] of the compact was measured with a B-H analyzer (SY-8218, manufactured by Iwatsu Electric Co., Ltd.). In the measurement of the iron loss Pcv, the measurement frequency was set to 100 kHz, and the maximum magnetic flux density Bm was set to 100 mT (=0.10 T).

### Measurement of Relative Permeability

In the measurement of a relative permeability, a coil was first wound around the compact fabricated as described above to thereby prepare an electronic component sample (here, a toroidal core). At this time, the number of turns in the coil was 40. Next, using the electronic component sample, the relative permeability μᵣ [−] of the compact was measured with an impedance analyzer (4192A, manufactured by Keysight Technologies).

### Measurement of Occupancy

In the measurement of an occupancy, the proportion of an area occupied by the plurality of soft magnetic metal particles in the area of a section of a composite particle contained in the powder-particle substance sample was measured.

Specifically, the powder-particle substance sample was first embedded in a resin to thereby prepare an embedded sample. Next, the embedded sample was polished by cross-section polisher processing (CP processing) to thereby expose a section of the granulated powder in the embedded sample (the composite particle in the powder-particle substance sample) on the surface. An image of the section was acquired using a scanning electron microscope (JSM7900F, manufactured by JEOL Ltd.). The image obtained was converted into a monochrome image (binary image) by binarization using image processing software to thereby clearly define the region of the soft magnetic metal particles (here, iron-base amorphous alloy powder) in the composite particle. Using this binary image, the area of the soft magnetic metal particles in the section (analysis region) in the composite particle was derived, and the area of the soft magnetic metal particles obtained was divided by the area of the analysis region and multiplied by 100 to calculate the occupancy R_{A} of the soft magnetic metal particles in the area of the section of the composite particle. PickMap was used as the image processing software, with a threshold set to 100.

### Examples 1 to 15

In each of Examples 1 to 15, the powder-particle substance sample prepared under the granulation conditions varied from Example to Example as described above was measured for the particle sizes D_{α}, D_{β}, and D_{γ} corresponding to peak tops in a particle size frequency distribution, the peak area ratios A_{α}, A_{β}, and A_{γ}, the average circularities C₁, C₂, and C₃, and the angle of repose φ according to the above-described methods.

Here, the particle size frequency distribution of the powder-particle substance sample is expressed by a particle group α (first peak) having a peak top where the particle size is the largest, a particle group β (second peak) having a peak top where the particle size is the second largest after the particle size at the first peak, and a particle group γ (third peak) having a peak top where the particle size is the smallest. The particle size D_{α} is a particle size at a peak top corresponding to the particle group α. The particle size D_{β} is a particle size at a peak top corresponding to the particle group β. The particle size D_{γ} is a particle size at a peak top corresponding to the particle group γ. The peak area ratio Aα is a peak area ratio corresponding to the particle group α. The peak area ratio A_{β} is a peak area ratio corresponding to the particle group β. The peak area ratio A_{γ} is a peak area ratio corresponding to the particle group γ. The average circularity C₁ is an average circularity of composite particles contained in a particle group having a particle size of 300 μm or more. The average circularity C₂ is an average circularity of composite particles contained in a particle group having a particle size of 45 μm or more and less than 300 μm. The average circularity C₃ is an average circularity of composite particles contained in a particle group having a particle size of less than 45 μm.

In the particle size frequency distribution of the powder-particle substance sample in each of Examples 9 to 12 and Example 15, the number of peak tops was two. Thus, the particle size frequency distribution was separated into two particle groups α and β. Therefore, in Examples 9 to 12 and Example 15, the particle size D_{γ} and the peak area ratio A_{γ} corresponding to the particle group γ were not defined. In addition, in these Examples, the amount of the particle group having a particle size of less than 45 μm was small, so that the average circularity C₃ was not measured.

The measurement results of the particle sizes D_{α}, D_{β}, and D_{γ}, the peak area ratios A_{α}, A_{β}, and A_{γ}, the average circularities C₁, C₂, and C₃, and the angle of repose φ in each of Examples 1 to 15 are as shown in Table 1. As shown in Table 1, the average circularity C₂ was 0.70 or more in each of Examples 1 to 15. Accordingly, in Examples 1 to 15, the angle of repose φ was significantly small, that is, the fluidity of the powder-particle substance was very high. For example, in each of Examples 1 to 15, the angle of repose φ was 36.0° or less. In particular, in Examples 1 to 14, the peak area ratio A_{β} was 0.20 or more. Accordingly, the angle of repose φ in each of Example 1 to 14 was smaller than that in Example 15 in which the peak area ratio A_{β} was less than 0.20. For example, in each of Examples 1 to 14, the angle of repose φ was 34.0° or less.

TABLE 1

| | Particle | | | Peak area | | | Average | | | Angle of |
|---|---|---|---|---|---|---|---|---|---|---|
| | size [μm] | | | ratio [—] | | | circularity [—] | | | repose [°] |
| | D_{α} | D_{β} | D_{γ} | A_{α} | A_{β} | A_{γ} | C₁ | C₂ | C₃ | φ |
| Example 1 | 493 | 146 | 19 | 0.45 | 0.40 | 0.15 | 0.74 | 0.73 | 0.67 | 33.1 |
| Example 2 | 488 | 110 | 25 | 0.46 | 0.41 | 0.13 | 0.72 | 0.77 | 0.81 | 31.4 |
| Example 3 | 505 | 215 | 41 | 0.38 | 0.52 | 0.10 | 0.69 | 0.81 | 0.77 | 32.5 |
| Example 4 | 510 | 358 | 75 | 0.53 | 0.39 | 0.08 | 0.75 | 0.82 | 0.79 | 31.2 |
| Example 5 | 487 | 130 | 21 | 0.25 | 0.70 | 0.05 | 0.71 | 0.73 | 0.62 | 32.4 |
| Example 6 | 499 | 151 | 22 | 0.50 | 0.49 | 0.01 | 0.76 | 0.75 | 0.61 | 31.1 |
| Example 7 | 487 | 212 | 33 | 0.48 | 0.40 | 0.12 | 0.72 | 0.80 | 0.68 | 32.6 |
| Example 8 | 433 | 241 | 35 | 0.55 | 0.42 | 0.03 | 0.71 | 0.72 | 0.71 | 32.0 |
| Example 9 | 398 | 199 | — | 0.48 | 0.52 | — | 0.77 | 0.81 | — | 30.5 |
| Example 10 | 403 | 350 | — | 0.76 | 0.24 | — | 0.61 | 0.75 | — | 33.3 |
| Example 11 | 466 | 333 | — | 0.59 | 0.41 | — | 0.58 | 0.74 | — | 33.5 |
| Example 12 | 491 | 296 | — | 0.34 | 0.66 | — | 0.55 | 0.75 | — | 33.2 |
| Example 13 | 638 | 258 | 118 | 0.75 | 0.23 | 0.01 | 0.76 | 0.74 | 0.65 | 33.4 |
| Example 14 | 698 | 228 | 88 | 0.64 | 0.33 | 0.03 | 0.77 | 0.78 | 0.64 | 33.4 |
| Example 15 | 493 | 134 | — | 0.96 | 0.04 | — | 0.62 | 0.75 | — | 34.2 |
| Comparative | 305 | 195 | 15 | 0.75 | 0.15 | 0.10 | 0.67 | 0.65 | 0.59 | 38.2 |
| Example 1 | | | | | | | | | | |
| Comparative | 445 | 212 | 22 | 0.82 | 0.06 | 0.12 | 0.62 | 0.62 | 0.71 | 37.1 |
| Example 2 | | | | | | | | | | |
| Comparative | 522 | 167 | 41 | 0.65 | 0.10 | 0.25 | 0.65 | 0.65 | 0.61 | 37.5 |
| Example 3 | | | | | | | | | | |
| Comparative | 493 | 144 | — | 0.70 | 0.30 | — | 0.63 | 0.66 | — | 36.3 |
| Example 4 | | | | | | | | | | |

### Comparative Examples 1 to 4

In each of Comparative Examples 1 to 4, the powder-particle substance sample prepared under the granulation conditions varied from Comparative Example to Comparative Example as described above was measured for the particle sizes D_{α}, D_{β}, and D_{γ} corresponding to peak tops in a particle size frequency distribution, the peak area ratios A_{α}, A_{β}, and A_{γ}, the average circularities C₁, C₂, and C₃, and the angle of repose φ in the same manner as in Examples 1 to 15.

In the particle size frequency distribution of the powder-particle substance sample of Comparative Example 4, the number of peak tops was two. Thus, the particle size frequency distribution was separated into two particle groups α and β. Therefore, in Comparative Example 4, the particle size D_{γ} corresponding to the particle group γ and the peak area ratio A_{γ} were not defined. In addition, in Comparative Example 4, the amount of the particle group having a particle size of less than 45 μm was small, so that the average circularity C₃ was not measured.

The measurement results of the particle sizes D_{α}, D_{β}, and D_{γ}, the peak area ratios A_{α}, A_{β}, and A_{γ}, the average circularities C₁, C₂, and C₃, and the angle of repose φ in each of Comparative Examples 1 to 4 are as shown in Table 1 above. As shown in Table 1, the average circularity C₂ was less than 0.70 in each of Comparative Examples 1 to 4. Accordingly, in Comparative Examples 1 to 4, compared with Examples 1 to 15, the angle of repose φ was significantly increased, and the fluidity of the powder-particle substance could not be sufficiently high. For example, in Comparative Examples 1 to 4, the angle of repose was more than 36.0°. In particular, in Comparative Examples 1 to 3 in which the peak area ratio A_{β} was less than 0.20, the angle of repose φ was more significantly increased.

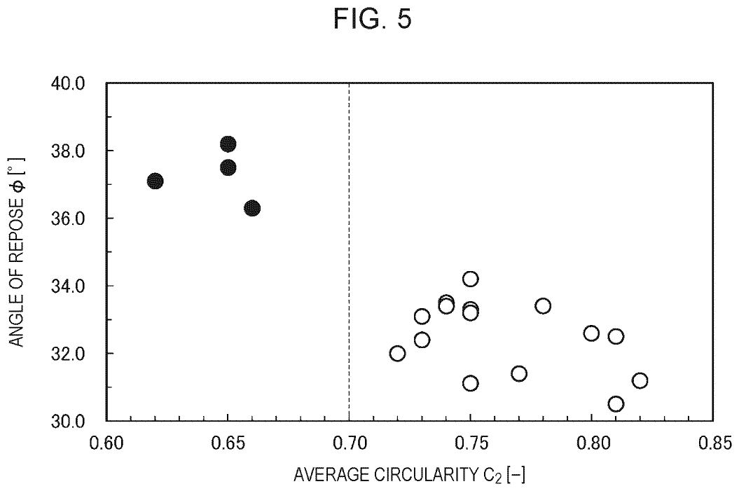

FIG. 5 is a graph showing the correlation between the average circularity C₂ and the angle of repose φ in each of Examples 1 to 15 and Comparative Examples 1 to 4. In FIG. 5, “∘” indicates the correlation between the average circularity C₂ and the angle of repose φ in each of Examples 1 to 15. “•” indicates the correlation between the average circularity C₂ and the angle of repose φ in each of Comparative Examples 1 to 4. As shown in FIG. 5, it is clear that in Examples 1 to 15 in which the average circularity C₂ is 0.70 or more, the angle of repose φ can be significantly small compared with any of Comparative Examples 1 to 4 in which the average circularity C₂ is less than 0.70.

### Examples 16 to 25

In each of Examples 16 to 25, the powder-particle substance sample prepared under the granulation conditions varied from Example to Example was measured for the particle sizes D_{α}, D_{β}, and D_{γ}, the peak area ratios A_{α}, A_{β}, and A_{γ}, the average circularities C₁, C₂, and C₃, and the angle of repose φ in the same manner as in Examples 1 to 15. This revealed that also in each of Examples 16 to 25, the particle size frequency distribution included two or more peaks, the average circularity C₂ was 0.70 or more, and the peak area ratio A_{β} was 0.20 or more.

In addition, in each of Examples 16 to 25, the powder-particle substance sample was measured for D50 in a cumulative particle size distribution, the ratio D90/D10, R2.0, D90p in a cumulative particle size distribution of soft magnetic metal particles, and the angle of repose φ according to the above-described methods. Furthermore, in each of Examples 16 to 25, the compact fabricated using the powder-particle substance sample was measured for the density ρ, the iron loss Pcv, and the relative permeability r according to the above-described methods.

The measurement results of D50, the ratio D90/D10, R2.0, D90p, the density ρ, the iron loss Pcv, and the relative permeability r in each of Examples 16 to 25 are as shown in Table 2. As shown in Table 2, in each of Examples 16 to 25, the value of the density ρ of the compact was as high as 5.50 or more. As a result, the iron loss Pcv of the compact was sufficiently small, and in addition the relative permeability r of the compact was sufficiently high. In particular, in Examples 18 to 25, D50 was 200 μm or more, and as a result, the density ρ of the compact was even higher.

TABLE 2

| | | D90/ | | | | ρ | Pcv | |
|---|---|---|---|---|---|---|---|---|
| | D50 | D10 | R2.0 | D90p | φ | [g/ | [kW/ | μᵣ |
| | [μm] | [—] | [%] | [μm] | [°] | cm3] | m3] | [—] |
| Example 16 | 76 | 2.7 | 96.0 | 107.7 | 27.2 | 5.51 | 386 | 42 |
| Example 17 | 185 | 5.6 | 77.0 | 352.0 | 31.7 | 5.33 | 521 | 35 |
| Example 18 | 384 | 20.9 | 82.4 | 21.5 | 34.1 | 5.61 | 353 | 46 |
| Example 19 | 522 | 25.1 | 94.2 | 21.5 | 34.2 | 5.60 | 342 | 47 |
| Example 20 | 574 | 6.3 | 84.9 | 21.7 | 32.8 | 5.60 | 340 | 47 |
| Example 21 | 236 | 7.5 | 87.2 | 21.7 | 33.3 | 5.62 | 335 | 48 |
| Example 22 | 314 | 10.0 | 87.5 | 21.8 | 32.9 | 5.62 | 335 | 47 |
| Example 23 | 343 | 8.7 | 91.9 | 21.7 | 32.8 | 5.61 | 341 | 47 |
| Example 24 | 582 | 6.0 | 81.1 | 136.1 | 32.1 | 5.71 | 420 | 52 |
| Example 25 | 434 | 7.7 | 84.4 | 55.2 | 32.5 | 5.55 | 425 | 52 |

In each of Examples 16 and 17 and Examples 20 to 25, the ratio D90/D10 was 20.0 or less. As a result, the angle of repose φ in each of Examples 16 and 17 and Examples 20 to 25 was smaller than those in Examples 18 and 19 in which the ratio D90/D10 was more than 20.0. That is, in Examples 16 and 17 and Examples 20 to 25, the fluidity of the powder-particle substance was even higher. For example, in each of Examples 16 and 17 and Examples 20 to 25, the angle of repose φ was 34.0° or less.

### Examples 26 and 27

In Example 26, the powder-particle substance sample prepared under the granulation conditions varied from Example to Example was measured for the particle sizes D_{α}, D_{β}, and D_{γ}, the peak area ratios A_{α}, A_{β}, and A_{γ}, the average circularities C₁, C₂, and C₃, and the angle of repose φ in the same manner as in Examples 1 to 15. In Example 27, the powder-particle substance sample was prepared in the same manner as in Examples 1 to 15 except that the method of granulating the powder-particle substance was changed to a spray drying method, and measured for the particle sizes D_{α}, D_{β}, and D_{γ}, the peak area ratios A_{α}, A_{β}, and A_{γ}, the average circularities C₁, C₂, and C₃, and the angle of repose φ. This revealed that also in each of Examples 26 and 27, the particle size frequency distribution included two or more peaks, the average circularity C₂ was 0.70 or more, and the peak area ratio A_{β} was 0.20 or more.

In addition, in each of Examples 26 and 27, the powder-particle substance sample was measured for the occupancy R_{A} of soft magnetic metal particles in composite particles according to the above-described method. Furthermore, in each of Examples 26 and 27, the compact fabricated using the powder-particle substance sample was measured for the relative permeability r according to the above-described method.

The measurement results of the occupancy R_{A} and the relative permeability μᵣ in each of Examples 26 and 27 are as shown in Table 3. As shown in Table 3, in Examples 26 and 27, although the method of granulating the powder-particle substance was changed, the occupancy R_{A} of soft magnetic metal particles in composite particles was high, and the powder-particle substance containing the soft magnetic metal particles in the composite particles at a high density was obtained. As a result, the relative permeability μᵣ of the compact in each of Examples 26 and 27 was sufficiently high. In particular, in Example 26, the occupancy R_{A} was 60% or more, and as a result, the soft magnetic metal particles in the composite particles was further densified, and the relative permeability μr of the compact was further increased.

TABLE 3

| | Occupancy R_{A} | Relative permeability μᵣ |
|---|---|---|
| | [%] | [—] |
| Example 26 | 64.3 | 47 |
| Example 27 | 53.7 | 42 |

The present invention is not limited to the embodiments and examples described above and includes products structured by appropriately combining the constituent elements described above. In addition, other embodiments, examples, operation techniques, and the like implemented by, for example, those skilled in the art according to the embodiments described above are all within the scope of the present invention.

1. A soft magnetic material comprising a powder-particle aggregate having a particle size frequency distribution having a plurality of peak tops,
wherein the powder-particle aggregate is an aggregate of composite particles containing a plurality of soft magnetic metal particles, the powder-particle aggregate including a medium-sized particle powder which is the composite particles having a particle size equal to or greater than 45 μm and smaller than 300 μm, and
wherein the medium particle powder has an average circularity equal to or greater than 0.7.

2. The soft magnetic material according to claim 1,
wherein the particle size frequency distribution is separated into a plurality of individual peaks each having a peak top corresponding to one of the plurality of peak tops, the plurality of individual peaks including:
a first peak having a first peak top, a first particle size corresponding to the first peak top having a largest value among a plurality of particle sizes corresponding to the plurality of peak tops; and
a second peak having a second peak top, a second particle size corresponding to the second peak top having a second largest value after the first particle size among the plurality of particle sizes,
and wherein a ratio A_{β} of a peak area of the second peak to a total area of the plurality of peaks is equal to or greater than 0.20.

3. The soft magnetic material according to claim 2,
wherein the plurality of individual peaks further include one or more third peaks each having a third peak top, a third particle size corresponding to the third peak top having a value smaller than the second particle size,
wherein a ratio A_{γ} of a sum of peak areas of the one or more third peaks to the total area of the plurality of peaks is equal to or smaller than 0.15, and
wherein the ratio A_{γ} is smaller than a ratio A_{α} of a peak area of the first peak to the total area of the plurality of peaks, and smaller than the ratio A_{β}.

4. The soft magnetic material according to claim 1,
wherein the powder-particle aggregate has a cumulative particle size distribution, in which a ratio D90/D10 obtained by dividing a particle size D90 corresponding to a cumulative frequency at 90% by a particle size D10 corresponding to a cumulative frequency at 10% is equal to or smaller than 20.0.

5. The soft magnetic material according to claim 1,
wherein the powder-particle aggregate has a cumulative particle size distribution, in a particle size D50 corresponding to a cumulative frequency at 50% is equal to or greater than 200 μm.

6. The soft magnetic material according to claim 5,
wherein the particle size D50 is equal to or smaller than 650 μm.

7. The soft magnetic material according to claim 1,
wherein the powder-particle aggregate has a cumulative particle size distribution, in which a particle size D90 corresponding to a cumulative frequency at 90% is equal to or smaller than 850 μm.

8. The soft magnetic material according to claim 1,
wherein a proportion of an area occupied by the plurality of soft magnetic metal particles relative to an area of the composite particles is equal to or greater than 60% in a cross-section of the composite particles.

9. The soft magnetic material according to claim 1,
wherein the powder-particle aggregate has a cumulative particle size distribution, in which a ratio D90/D10 obtained by dividing a particle size D90 corresponding to a cumulative frequency at 90% by a particle size D10 corresponding to a cumulative frequency at 10% is equal to or greater than 5.0 and equal to or smaller than 11.0, and a particle size D50 corresponding to a cumulative frequency at 50% is equal to or greater than 200 μm and equal to or smaller than 460 μm, and
wherein with respect to 100 or more composite particles of the powder-particle aggregate, a proportion of the composite particles having a ratio Dₘₐₓ/Dₘᵢₙ, which is a ratio of a maximum diameter Dₘₐₓ to a minimum diameter Dₘᵢₙ, equal to or smaller than 2.0 is equal to or greater than 80%.

10. The soft magnetic material according to claim 1,
wherein the composite particles contain a binder binding the plurality of soft magnetic metal particles together, a hardness of the binder being not greater than 0.25 times a hardness of the soft magnetic metal particles,
wherein the soft magnetic metal particles are amorphous soft magnetic particles, and
wherein the plurality of soft magnetic metal particles have a cumulative particle size distribution, in which a particle size D90p corresponding to a cumulative frequency at 90% is equal to or smaller than 150 μm.

11. An electronic component comprising:
the soft magnetic material according to claim 1.
